(19) United States
(12) Patent Application Publication
(10) Pub. No.: US 2013/0332291 A1
(43) Pub. Date: Dec. 12, 2013

(54) SHOPPING INFORMATION SYSTEM AND METHOD

(71) Applicant: Arturo Juan PEREZ, Vaughan (CA)

(72) Inventor: Arturo Juan PEREZ, Vaughan (CA)

(21) Appl. No.: 13/838,448

(22) Filed: Mar. 15, 2013

Related U.S. Application Data
(60) Provisional application No. 61/657,158, filed on Jun. 8, 2012.

(51) Int. Cl. G06Q 30/06

(52) U.S. Cl. CPC G06Q 30/0623
USPC 705/14.73

(57) ABSTRACT

A shopping information system comprises an application server in communication with a database comprising price information for each of a plurality of retail products for at least one store, and at least one computing device in communication with the application server. The at least one computing device is configured to display a user interface for creating a list of one or more retail products by sequentially selecting, at least, category information, sub-category information and brand information displayed for each of the one or more retail products, the brand information being displayed in accordance with an advertisement ranking; send a request to the application server for price information of the one or more retail products; and display requested price information of the one or more retail products for one or more of the at least one store.

### CROSS-REFERENCE TO RELATED APPLICATION

This application claims the benefit of U.S. Provisional Application Ser. No. 61/657,158 filed on Jun. 8, 2012 and entitled “SHOPPING INFORMATION SYSTEM AND METHOD”, the content of which is incorporated herein by reference in its entirety.

### FIELD OF THE INVENTION

The present invention relates to a shopping information system and method.

### BACKGROUND OF THE INVENTION

Many shoppers carry portable wireless computing devices, such as cellular telephones or portable media players, with them while they are shopping at retail stores. Present-day portable wireless computing devices typically comprise high quality displays, extensive memories and extensive application execution capabilities, and are commonly referred to as “smart” devices. Present-day cellular telephones, commonly referred to as “smartphones”, not only support voice communications, but also have extensive data communication capabilities using various protocols, such as the Internet Protocol.

Shoppers can also shop for retail products, such as for example groceries, on-line through the use of various Internet websites. Many of these websites include an extensive list of retail products available from a respective retailer, and comprise information about each retail product, such as the price, the available sizes, the quantity available, etc. Most of these websites use so-called “shopping cart” software for holding retail products selected by users as they shop on-line, and for simplifying the checkout and purchasing process.

Shopping information systems that generally facilitate the shopping experience have been previously described. For example, U.S. Patent Application Publication No. 2004/0093274 to Vanska et al. discloses an apparatus and method for facilitating a shopping experience. A user creates and stores a shopping list in a mobile terminal. Upon entering a shop, the mobile terminal downloads a shopping mini-application, which checks item availability and provides recommended substitute and complimentary items preferably taking user profile information into consideration. The mobile terminal also provides the user with reminders based on the user's purchasing history. Special offers are also presented to the user. Once the shopping list has been finalized, an optimal shopping route is computed for gathering the items on the list and is displayed to the user in the form of a map. The optimal route and recommendations may be updated at any time throughout the shopping experience in response to either the user's request, modifications to the shopping list and/or the user's divergence from the optimal route.

U.S. Pat. No. 7,424,447 to Fuzell-Casey et al. discloses a system and method for enabling a user to create a list of items on a portable computing device, to communicate with external devices to locate each of the items available on the list within a geographically limited area, to provide users with visual or aural cues as to the location of items on the list, to progress through the list of items as each item is selected or rejected, and providing discounts toward, information about, or alternatives to the available items on the list.

U.S. Pat. No. 7,707,073 to Bloebaum et al. discloses methods for providing augmented shopping information to a user of a mobile terminal in a store including providing a shopping list identifying a plurality of items, and obtaining information regarding physical locations of respective ones of the items in the store. The location of the mobile terminal in the store is established. An image of a view from the location is obtained. An item having an associated location in the obtained image is identified based on the obtained information regarding physical locations. A position within the image corresponding to the respective physical location of the identified item is determined. A graphic indication of the identified item is added to the obtained image at the determined position within the image to provide an augmented image of the view that is displayed to the user on a display of the mobile terminal.

U.S. Patent Application Publication No. 2007/0150369 to Zivin discloses a method and system for providing customers with means to determine a) how far a customer should be willing to travel to a vendor to purchase locally sold goods and b) what routes the customer should take to minimize his or her total costs. Customers use an Internet search engine to find products or services that they are interested in purchasing in their local area. The search results provide a list of goods along with their current price and store location. Customers select one or more goods they are interested in purchasing and add these goods to a shopping list. A recommendation is provided based on variables such as the customer's estimated value of time, traffic conditions, gas prices, parking fees, automobile miles per gallon, the difference in prices between stores, or other relevant variables. The recommendation informs the customers as to vendors at which he or she should purchase goods and the order in which the locations should be visited so as to minimize total purchase costs.

Improvements are generally desired. It is therefore an object of the present invention at least to provide a novel shopping information system and method.

### SUMMARY OF THE INVENTION

Accordingly, in one aspect there is provided a method comprising: creating, using a computing device, a list of one or more retail products by sequentially selecting, at least, category information, sub-category information and brand information displayed for each of said one or more retail products, said brand information being displayed in accordance with an advertisement ranking; sending a request to an application server for price information of said one or more retail products, the application server being in communication with a database comprising price information for each of said one or more retail products for at least one store; and displaying, on the computing device, requested price information of said one or more retail products for one or more of said at least one store.

The method may further comprise sending an initial request to the application server for said brand information. The application server may provide said advertisement ranking.

The method may further comprise displaying, on the computing device, a graphical advertisement image received from the application server.

The displaying may further comprise displaying, on the computing device, a graphical image of each of said one or more retail products.

The application server may apply coupon information to said price information, said requested price information being reduced by said coupon information.

The application server may also be in communication with at least one store server maintaining a current inventory information database comprising current inventory information for a respective one of said at least one store, and wherein said sending further comprises: sending a request for current inventory information of said one or more retail products, and wherein said displaying further comprises: displaying requested current inventory information of said one or more retail products for said respective store.

The computing device may be a portable wireless computing device. The computing device may be a smartphone.

The method may further comprise sending the list of one or more retail products to another computing device as a shared list.

The creating may further comprise sequentially selecting the category information and the sub-category information from a predefined subset of category information and sub-category information, said predefined subset corresponding to commonly-purchased retail items. The method may further comprise adding one or more of a user-defined category and a user-defined sub-category to said predefined subset. The method may further comprise associating a selected retail product with said user-defined sub-category.

In another aspect, there is provided a non-transient computer-readable medium storing computer-readable code which, when executed, causes a computing device to: display a user interface for creating a list of one or more retail products by sequentially selecting, at least, category information, sub-category information and brand information displayed for each of said one or more retail products, said brand information being displayed in accordance with an advertisement ranking; send a request to an application server for price information of said one or more retail products, the application server being in communication with a database comprising price information for each of said one or more retail products for at least one store; and display requested price information of said one or more retail products for one or more of said at least one store.

The non-transient computer-readable may further comprise computer-readable code which, when executed, causes the computing device to send an initial request to the application server for said brand information.

The non-transient computer-readable may further comprise computer-readable code which, when executed, causes the computing device to display a graphical advertisement image received from the application server.

The non-transient computer-readable may further comprise computer-readable code which, when executed, causes the computing device to display a graphical image of each of said one or more retail products.

The application server may also be in communication with at least one store server maintaining a current inventory information database comprising current inventory information for a respective one of said at least one store, and the non-transient computer-readable may further comprise computer-readable code which, when executed, causes the computing device to send a request for current inventory information of said one or more retail products, and display requested current inventory information of said one or more retail products for said respective store.

The non-transient computer-readable may further comprise computer-readable code which, when executed, causes the computing device to send a price check request to the application server, the price check request comprising barcode information associated with a desired retail product and current position information of the computing device; and display price information of said desired retail product for a store associated with the current position information. The computing device may be a portable wireless computing device.

The non-transient computer-readable may further comprise computer-readable code which, when executed, causes the computing device to capture one or more images of the desired retail product using an imaging device of the computing device; and process the one or more images to extract the barcode information.

The non-transient computer-readable may further comprise computer-readable code which, when executed, causes the computing device to send the list of one or more retail products to another computing device as a shared list.

The non-transient computer-readable may further comprise computer-readable code which, when executed, causes the computing device to sequentially select the category information and the sub-category information from a predefined subset of category information and sub-category information, said predefined subset corresponding to commonly-purchased retail items. The non-transient computer-readable may further comprise computer-readable code which, when executed, causes the computing device to add one or more of a user-defined category and a user-defined sub-category to said predefined subset. The non-transient computer-readable may further comprise computer-readable code which, when executed, causes the computing device to associate a selected retail product with said user-defined sub-category.

In another aspect, there is provided a shopping information system comprising: an application server in communication with a database comprising price information for each of a plurality of retail products for at least one store; and at least one computing device in communication with the application server, the at least one computing device being configured to: display a user interface for creating a list of one or more retail products by sequentially selecting, at least, category information, sub- category information and brand information displayed for each of said one or more retail products, said brand information being displayed in accordance with an advertisement ranking; send a request to the application server for price information of said one or more retail products; and display requested price information of said one or more retail products for one or more of said at least one store.

The at least one computing device may be further configured to send an initial request to the application server for said brand information.

The at least one computing device may be further configured to display a graphical advertisement image received from the application server.

The at least one computing device may be further configured to display a graphical image of each of said one or more retail products.

The at least one computing device may be further configured to receive coupon information associated with said one or more retail products.

The at least one computing device may be further configured to send a price check request to the application server, the price check request comprising barcode information associated with a desired retail product and current position information of the computing device; and display price information of said desired retail product for a store associated with the current position information. The computing device may be a portable wireless computing device. The at least one computing device may be further configured to capture one or more images of the desired retail product using an imaging device of the computing device; and process the one or more images to extract the barcode information.

The application server may also be in communication with at least one store server maintaining a current inventory information database comprising current inventory information for a respective one of said at least one store, and wherein the at least one computing device may be further configured to: send a request for current inventory information of said one or more retail products, and display requested current inventory information of said one or more retail products for said respective store.

The at least one computing device may be further configured to send the list of one or more retail products to another computing device as a shared list.

The at least one computing device may be further configured to sequentially select the category information and the sub-category information from a predefined subset of category information and sub-category information, said predefined subset corresponding to commonly-purchased retail items. The at least one computing device may be further configured to add one or more of a user-defined category and a user-defined sub-category to said predefined subset. The at least one computing device may be further configured to associate a selected retail product with said user-defined sub-category.

### BRIEF DESCRIPTION OF THE DRAWINGS

Embodiments will now be described more fully with reference to the accompanying drawings in which:

FIG. 1 is a schematic view of a shopping information system;

FIG. 2 is a lists page presented by an application program used by the shopping information system of FIG. 1;

FIG. 3 is a list builder page presented by the application program;

FIG. 4 is a category selection page presented by the application program;

FIG. 5 is an item selection page presented by the application program;

FIG. 6 is an item display page presented by the application program;

FIG. 7 is a find store page presented by the application program;

FIG. 8 is a stores page presented by the application program;

FIG. 9 is a store summary page presented by the application program;

FIG. 10 is a purchase lists page presented by the application program;

FIG. 11 is an active purchase list page presented by the application program;

FIG. 12 is a coupon display page presented by the application program;

FIG. 13 is a shared lists page presented by the application program;

FIG. 14 is a fridge check page presented by the application program; and

FIG. 15 is a coupons page presented by the application program.

### DETAILED DESCRIPTION OF THE EMBODIMENTS

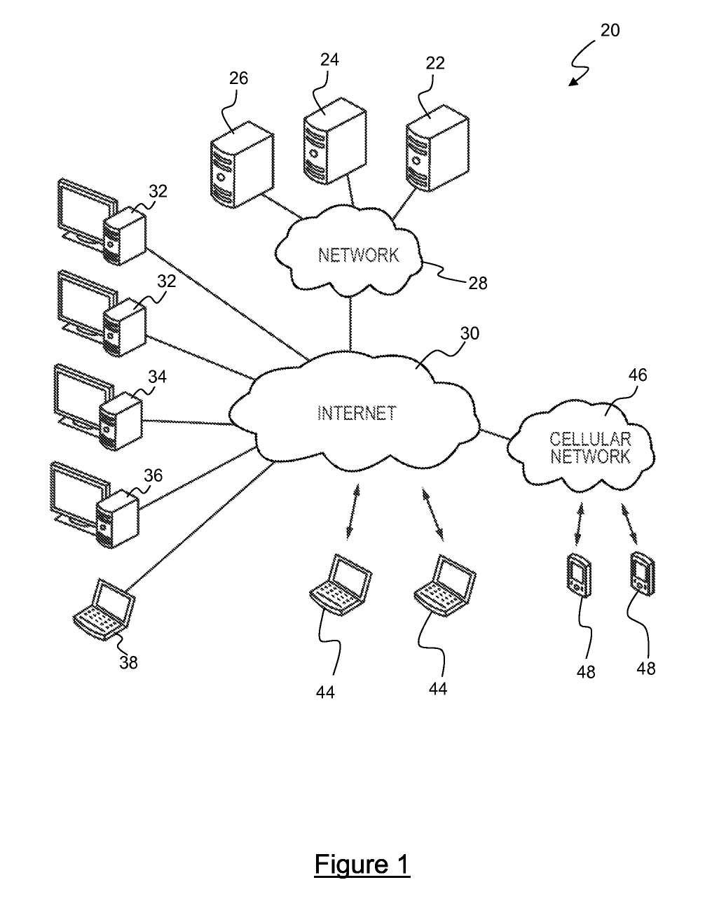

Turning now to FIG. 1, a shopping information system is shown and is generally identified by reference numeral 20. System 20 comprises a plurality of general purpose computing devices, and namely an application server 22, a store controller server 24 and a store portal server 26, that are in communication with each other via a local area network (LAN) 28.

The application server 22 is configured to run a shopping information application for managing the shopping information system 20 and the operations of the application server 22, the store controller server 24 and the store portal server 26. The shopping information application is also configured to maintain within the application server 22 a retail product database of retail product information relating to commercially available retail products. In this embodiment, the retail products are grocery products, however it will be understood that in other embodiments, the retail products may be other kinds of products.

The retail product information stored in the retail product database comprises, for each retail product: product categorizing information, a product code number, a product description, and a graphical image. In this embodiment, for each retail product, the product categorizing information comprises a category, a sub-category, a sub-sub-category, and a brand. For example, for a category of “dairy”, there may be retail products in the retail product database having values of sub-category of “milk”, “cheese”, “butter & margarine”, “yogurt” and “ice cream”. For the sub-category of “milk”, for example, there may be retail products in the retail product database having values of sub-sub-category of “skim”, “partly skim 1%”, “partly skim 2%”, “whole” and “lactose free”. Each value of brand comprises a brand name and size information of the retail product. For example, for the sub-sub-category of “skim”, there may be retail products in the retail product database having values of brand of “Beatrice™ 1 L carton”, “Beatrice™ 4 L bags”, “Natrel™ 1 L carton”, “Natrel™ 4 L bags”, and “Nelson™ 4 L bags”. Each value of product description comprises a concise text description of the retail product. For example, for the sub-sub-category of “skim” and for the brand of “Beatrice™ 1 L carton”, the product description of the retail product may have a value of “skim 1 L carton”. In this embodiment, each product code number is a Universal Product Code (UPC)-A number, and each graphical image is a photographic image of the retail product.

The local area network 28 is in communication with an Internet network 30. In this embodiment, the system 20 further comprises additional general purpose computing devices, namely a plurality of store servers 32, one or more servers 34, one or more servers 36, and one or more computing devices 38, that are in communication with the Internet network 30. In the embodiment shown, the system 20 comprises two (2) store servers 32, however it will be understood that the system may comprise fewer (i.e. zero (0) or one (1)) or more than two (2) store servers 32. Similarly, in the embodiment shown, the system 20 comprises one (1) server 34, one (1) server 36, and one (1) server 36, however it will be understood that the system may comprise fewer than (that is, zero (0)) or more than one (1) of each of server 34, server 36 and computing device 38.

Each store server 32 is associated with a respective retail store (not shown), and has a real-time inventory application running thereon that monitors the current price, the product code number, the current inventory and the in-store location of retail products sold in the retail store. The current inventory is the quantity of the retail product currently available for purchase in the store, and the in-store location information comprises a row number and a shelf number of the retail product within the store. The real-time inventory application also maintains, and updates in real-time, an inventory database of the current inventory, the current price, the product code number and the in-store location of the retail products sold in the retail store. Whenever the current price of one or more retail products changes in the inventory database, each store server 32 is configured to automatically send a price list update comprising the store name, and the current price information and product code number of the one or more retail products, to the store controller server 24.

Each server 34 is associated with a respective single store (not shown), or with a respective plurality of stores (not shown) such as for example a chain of stores, and maintains a price database of the current price and the product code number of retail products sold in the single store or in the plurality of stores associated therewith. The price database maintained by the server 34 may be updated, as needed, by a registered user associated with the single store or with the plurality of stores. Each server 34 is configured to receive periodic price list requests from the store controller server 24. Upon receiving a price list request, each server 34 is configured to obtain from the price database the current price information and the product code numbers, and to send a price list update comprising the store name, the current price information and the product code numbers, to the store controller server 24. In this embodiment, the price list requests and the price list updates are sent using the File Transfer Protocol (FTP) over a virtual private network (VPN).

Each server 36 is associated with a respective single store (not shown), or with a respective plurality of stores (not shown) such as for example a chain of stores, and maintains a price database of the current price and product code number of retail products sold in the single store or in the plurality of stores associated therewith. The price database maintained by the server 36 may be updated, as needed, by a registered user associated with the single store or with the plurality of stores. Each server 36 is configured to, upon direction by a registered user of the server 36, to upload a price list update comprising the store name, the current price information and the product code numbers, to the store controller server 24 via a price update Internet website hosted therein, as desired. In this embodiment, the price list requests and the price list updates are sent using the File Transfer Protocol (FTP) over a virtual private network (VPN).

Each computing device 38 is associated with one or more registered users who are authorized by a respective single store (not shown), or by a respective plurality of stores (not shown) such as for example a chain of stores, has and stored therein an current price list comprising current price information and product code numbers of retail products sold in the single store or in the plurality of stores associated therewith. The current price list stored in the server 34 may be updated, as needed, by a registered user associated with the single store or with the plurality of stores. Each computing device 38 is configured to, upon direction by a registered user of the computing device 38, to upload a price list update comprising the store name, the current price information of the retail products, and their associated product code numbers, to the store controller server 24 via the price update Internet website, as desired.

The system 20 further comprises a plurality of computing devices 44 that are in communication with the Internet network 30. Each computing device 44 is configured to communicate with the shopping information application running on the application server 22 through an Internet web browser application running on the computing device 44. Each computing device 44 may communicate with the Internet network 30 over any of a wireless connection, a wired connection or a combined wireless/wired connection. In the embodiment shown, the computing devices 44 are general purpose computing devices in the form of laptop personal computers, however, it will be understood that the computing devices 44 may alternatively be other kinds of computing devices, such as for example desktop personal computers, notebook computers, smartphones, portable media players, tablet computers, and the like.

The computing devices 44 are configured to send, via the Internet web browser application, brand requests and submitted lists to the application server 22, and to receive catalog information, brand replies, stores lists and graphical advertisement images from the application server 22.

The Internet network 30 is in communication with a cellular network 46. The system 20 further comprises a plurality of computing devices 48 in communication with the cellular network 46. Each computing device 48 is a portable wireless computing device, and is configured to communicate with the shopping information application running on the application server 22 through an application program running on the computing device 48. Each computing device 48 comprises a display and an imaging device, such as for example a camera, which is capable of capturing digital images. In the embodiment shown, the participant devices 48 are smartphones and the application program is a “mobile app”, however, it will be understood that the participant devices 48 may alternatively be other kinds of portable wireless computing devices, such as for example portable media players, tablet computers, notebook computers, and the like.

The computing devices 48 are configured to send, via the application program, brand requests and submitted lists to the application server 22, and to receive catalog information, brand replies, stores lists and graphical advertisement images from the application server 22.

The application server 22 is also configured to run an advertising engine within the shopping information application. The advertising engine is configured to provide two services, namely a ranking service and an advertisement display service. The ranking service is configured to define preferences pertaining to retail product brand ranking, in accordance with desired brand rankings requested by advertisers. In this embodiment, an advertiser may request a brand ranking of first, second or third. The advertisement display service is configured to provide the graphical advertisement images for display on computing devices 44 and 48 in accordance with criteria requested by advertisers. In this embodiment, the criteria are requested target demographics of retail products, and requested affiliation of the graphical advertisement images with specified retail products.

The store controller server 24 is configured to communicate with the store servers 32 for receiving the price list updates sent automatically by each store server 32, and for sending current status information requests thereto. Upon receiving a current status information request, each store server 32 is configured to obtain from its inventory database the current inventory information and the in-store location information of each retail product listed in the request, and to communicate this obtained information to the store controller server 24. As noted above, the store controller server 24 is also configured to communicate with the servers 34 for sending price list requests thereto periodically.

The store controller server 24 also maintains a store controller database of all product code numbers of all retail products sold in that are affiliated with the system 20. The store controller database further comprises, for each product code number, one or more store names, as well as the current price information for each respective store name. The store controller server 24 is configured to continuously update in real-time the current price information within the store controller database as each price list update is received. The store controller server 24 is also configured to host the price update Internet website, through which registered users affiliated with any of store servers 32, servers 34 and 36, and computing devices 38, can voluntarily upload price list updates comprising the store name, the current price information, and the associated product code numbers for storage in the store controller database.

The store portal server 26 is configured to communicate with the advertising engine running on the application server 22, and to run an advertising analytics engine. The advertising analytics engine is configured to measure performance of advertisements, and to generate advertising analytics for advertisers of the performance of their respective advertisements. In this embodiment, the advertising analytics engine generates basic analytics, which includes the number times graphical advertisement images of an advertised brand were displayed on computing devices 44 and 48, and the number of times the advertised brand appeared in brand rankings The advertising analytics engine also generates complex analytics, which includes any measured increase in the number of times advertised retail products or advertised brands appear in submitted lists during an advertising campaign, selection of advertised products or advertised brands as a function of demographics of users of computing devices 44 and 48, and a ranking of stores for which the advertised product was displayed.

The store portal server 26 is also configured to host a portal Internet website, through which registered users may upload promotional information for retail products sold in stores associated with the store servers 32, stores associated with servers 34 and 36, and stores associated the registered users of computing devices 38, and through which advertisers may upload promotional information. In this embodiment, the promotional information comprises promotional price information and coupon information. The promotional price information comprises current price information and product code number(s), and the coupon information comprises a coupon graphical image that includes barcode information comprising a price reduction information and product code number(s) for at least one associated retail product, as well as a text description of the at least one associated retail product and promotional details associated therewith. Upon receiving promotional price information, the store portal server 26 is configured to send the promotional price information to the store controller server 24 for updating the current price information within the store controller database.

The store portal server 26 is further configured to record market information, and to communicate the market information to registered users via the portal Internet website. The market information comprises demand of retail products submitted by the participant devices 44 and 48, and is devoid of any personal information about users of the participant devices 44 and 48.

Turning now to the application program, the application program installed on each computing device 48 is configured to present a graphical user interface on the display of the computing device 48. The graphical user interface comprises a variety of different pages. Although in this embodiment the computing devices 48 are smartphones and the pages displayed by the graphical user interface are generally sized for display on a smartphone display, it will be understood that the application program displays similar pages that may be differently sized, as appropriate, on other kinds of computing devices 48.

When launched on the computing device 48, the application program is configured to contact the application server 22 and to download catalog information of all retail products stored in the retail product database, as well as saved lists previously saved by the computing device 48, into memory of the computing device 48. The downloaded catalog information comprises a high-level portion of the categorizing information, namely the category information, the sub-category information and the sub-sub-category information, for all retail products stored in the retail product database.

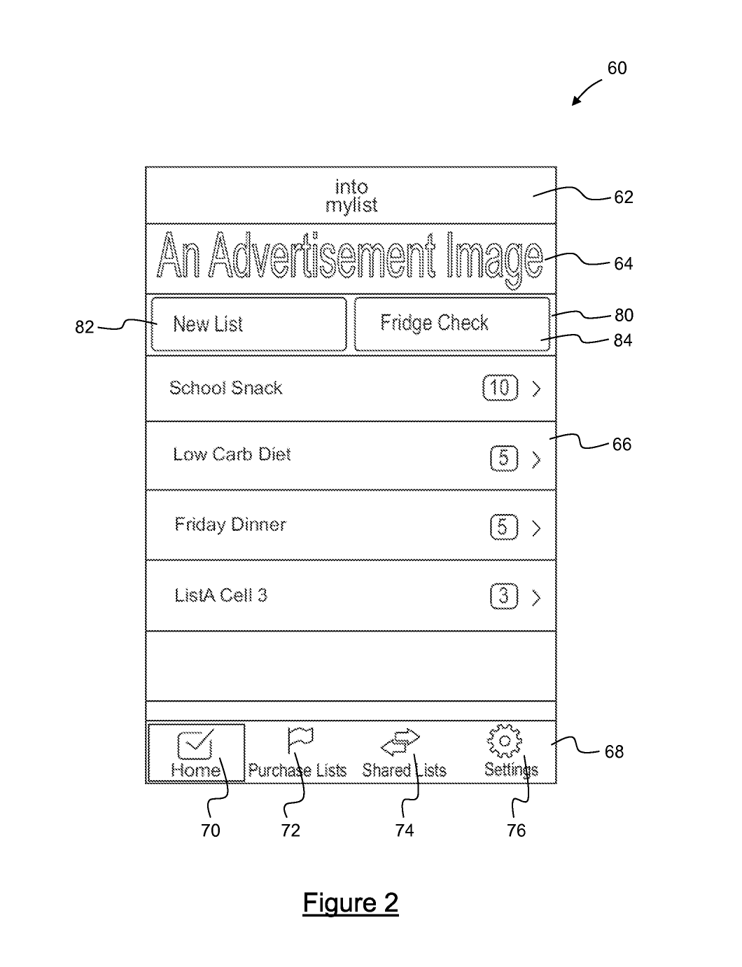

Once the saved lists and catalog information have been downloaded, the application program displays a lists page on the display of the computing device 48. FIG. 2 shows the lists page, which is generally referred to using reference numeral 60. The lists page 60 comprises a header region 62 in which a name of the application program is displayed. In the example shown, the name of the application program is intomylist™. The lists page 60 also comprises an advertising banner 64, in which a graphical advertisement image comprising an embedded web link (not shown) to an advertiser's webpage is displayed. The graphical advertisement image may be selected by a user, which opens a web browser window in which the advertiser's webpage is displayed. The lists page 60 also comprises a display area 66, in which the downloaded saved lists are shown. Each of the saved lists shown in the display area 66 may be selected for displaying the saved list. The lists page 60 also comprises a menu bar 68 that has a plurality of virtual buttons, each of which may be selected by the user for carrying out a different respective function. In this embodiment, the virtual buttons include a home button 70, a purchase lists button 72, a shared lists button 74 and a settings button 76. The lists page 60 also comprises a function bar 80 that comprises two (2) virtual buttons, namely a “New List” button 82, which may be selected by the user for creating a new list, and a “Fridge Check” button 84.

Once an active list is available, and namely once a new list has been created or once a saved list has been selected, the application program displays a list builder page on the display of the computing device 48.

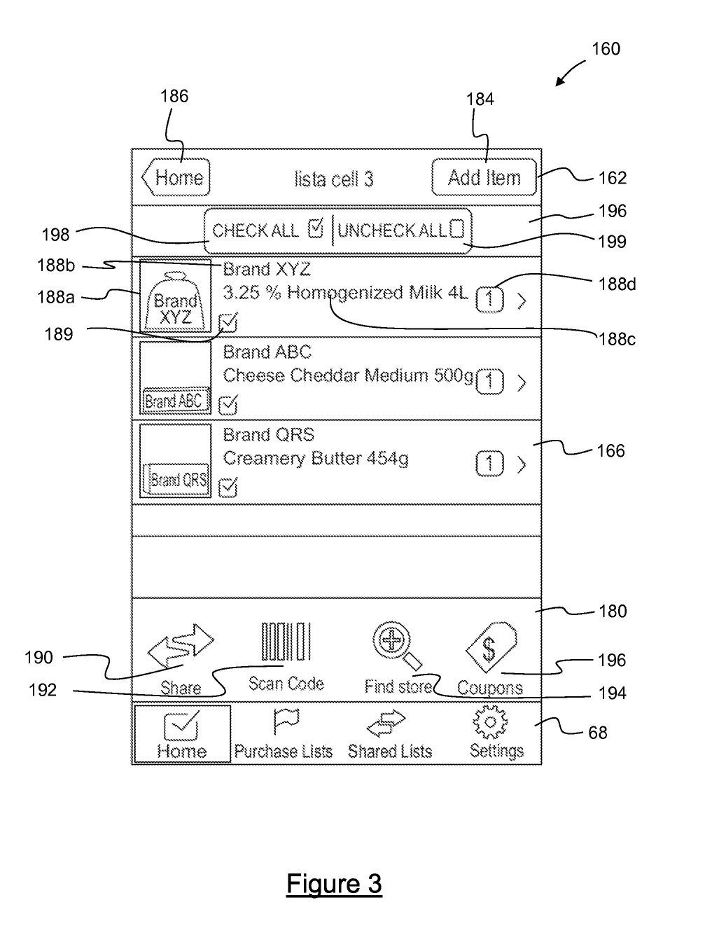

FIG. 3 shows the list builder page, which is generally referred to using reference numeral 160. List builder page 160 comprises a header region 162 in which the name of the active list is shown. In the example shown, the active list is a saved list that has been selected, and is named “lista cell 3”. The header region 162 comprises two (2) virtual buttons, namely an add item button 184, which may be selected by the user for adding a retail product to the active list, and a home button 186, which may be selected by the user for returning to the lists page 60. The list builder page 160 also comprises a display area 166, in which retail products that have been added to the active list are listed. In the embodiment shown, the graphical image 188a, a brand name 188b of the brand, the product description 188c and a quantity 188d are shown for each retail product listed in the active list. Additionally, the display area 166 also comprises a check box 189 beside each retail product listed in the active list, which may be selected by the user to indicate either a selection or a deselection of the product. The list builder page 160 also comprises a function bar 196 that comprises two (2) virtual buttons, namely a “check all” button 198, which may be selected by the user to indicate a selection of all of the retail products listed in the active list, and an “uncheck all” button 199, button 198, which may be selected by the user to indicate a deselection of all of the retail products listed in the active list.

The list builder page 160 also comprises a function bar 180 that has a plurality of virtual buttons, namely: a share button 190, which may be selected by the user for sending the active list to another user; a scan code button 192; a find store button 194; and a coupons button 196.

The application program allows the user to add each individual retail product to the active list separately. In this embodiment, the application program allows the user to add each individual retail product to the active list by selecting the category, the sub-category, the sub-sub-category and the brand of the retail product sequentially.

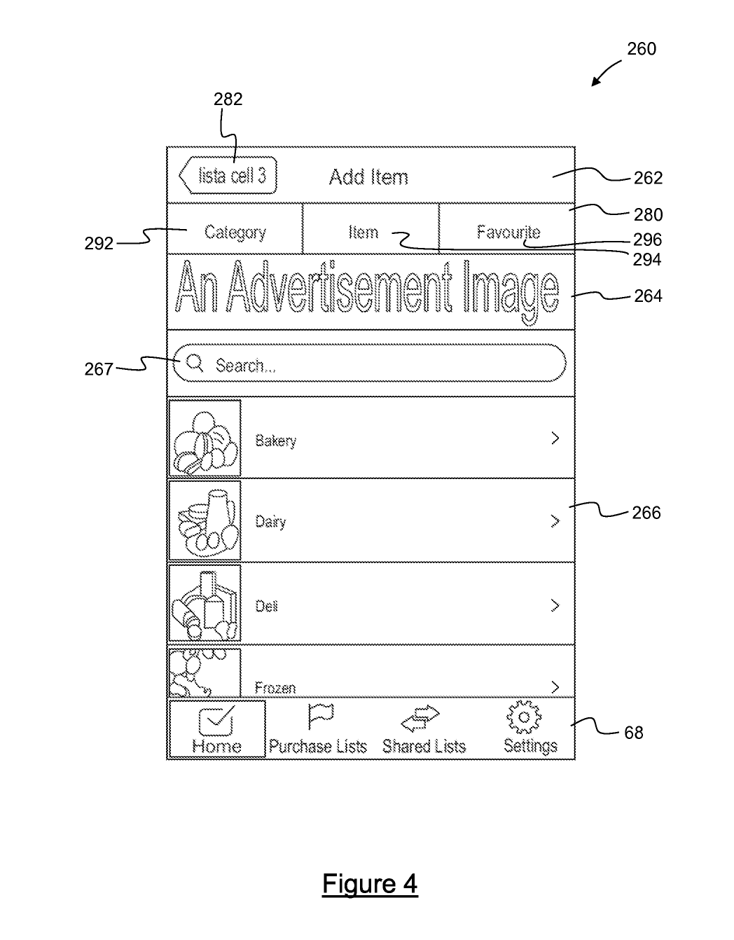

Upon selection of the add item button 184, the application program displays a category selection page on the display of the computing device 48. FIG. 4 shows the category selection page, which is generally referred to using reference numeral 260. The category selection page 260 comprises a header region 262 comprising a virtual button, and namely a return button 282, which may be selected by the user for returning to the list builder page 260. The category selection page 260 also comprises a display area 266 in which all categories of the downloaded catalog information are listed in alphabetical order. Each category listed in the display area 266 may be selected by the user for displaying all sub-categories of that category on a sub-category selection page (not shown). The category selection page 260 also comprises a free text search field 267, in which the user may enter text for conducting a search of the downloaded catalog information for descriptions matching the entered text. Upon finding one or more matching descriptions, the application program displays the matching items on a search results page (not shown), and with each displayed matching item being selectable for displaying one of the category selection page, a sub-category selection page, a sub-sub-category selection page, and an item display page, as appropriate.

The category selection page 260 also comprises a function bar 280 that has a plurality of virtual buttons, namely a category button 292, an item button 294 and a favourite button 296. The category button 292 may be selected by the user for displaying all categories of the retail products of the catalog. The item button 294 may be selected for causing the application program to contact the application server 22 and to download the brand information for all retail products stored in the retail product database, and for displaying a full catalog page (not shown) in which all retail products are displayed and in which one of the displayed retail products may be selected for adding the retail product to the active list. The favourite button 296 may be selected for displaying a favourites list page (not shown) in which retail products previously identified by the user as favorite retail products are displayed and in which each favorite retail product may be selected for adding the retail product to the active list. The category selection page 260 also comprises an advertising banner 264, in which a graphical advertisement image comprising an embedded web link (not shown) to an advertiser's webpage is displayed, and which may be selected by the user to open a web browser window in which the advertiser's webpage is displayed. The category selection page 260 further comprises the menu bar 68, which has been described above for the lists page 60 and with reference to FIG. 2.

Once a category has been selected using the category selection page 260, a sub-category is then selected using the above-mentioned sub-category selection page (not shown). The sub-category selection page is generally similar to the category selection page 260, but comprises a display area (not shown) in which all sub-categories of the selected category are listed in alphabetical order. Each sub-category listed in the display area may be selected by the user for displaying all sub-sub-categories of that sub-category on a sub-sub-category selection page (not shown).

Once a sub-category has been selected using the sub-category selection page, a sub-sub-category is then selected using the above-mentioned sub-sub-category selection page (not shown). The sub-sub-category selection page is generally similar to the category selection page 260, but comprises a display area (not shown) in which all sub-sub-categories of the selected sub-category are listed in alphabetical order. Each sub-sub-category listed in the display area may be selected by the user.

Once a sub-sub-category has been selected, the application program directs the computing device 48 to send a brand request, which comprises the selected category, the selected sub-category, and the selected sub-sub-category to the application server 22. Upon receiving the brand request, the application server 22 searches the retail product database and obtains a list of all brands having the selected category, the selected sub-category and the selected sub-sub-category. The application server 22 then checks the advertising engine and determines a brand ranking of at least some of the brands obtained during the search, according to the preferences defined by the advertising engine. The application server then obtains the production description and the graphical image for each retail product having the selected category, the selected sub-category, the selected sub-sub-category, and a brand obtained during the search. The application server 22 then sends a brand reply comprising the list of brands obtained during the search, the graphical images, the product descriptions, and the brand ranking to the requesting computing device 48.

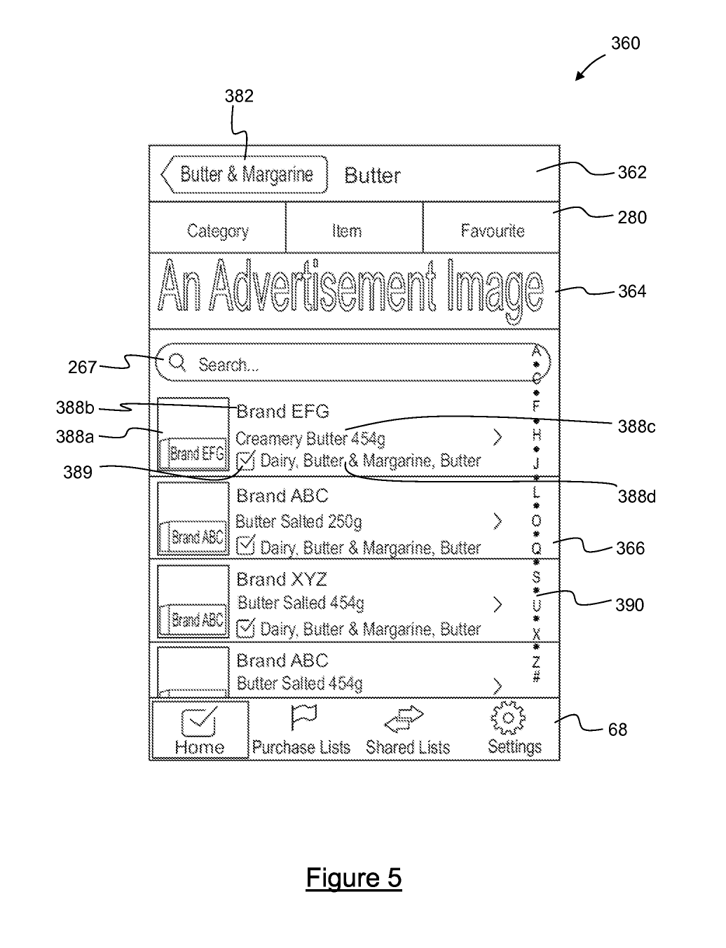

Upon receiving the brand reply, the application program displays an item selection page on the display of the computing device 48. FIG. 5 shows the item selection page, which is generally referred to using reference numeral 360. The item selection page 360 comprises a header region 362 in which the selected sub-sub-category is displayed. In the example shown, the selected sub-sub-category is “Butter”. The header region 362 also comprises a virtual button, namely a return button 382, in which the selected sub-category is displayed, and which may be selected by the user for returning to the sub-category selection page. The item selection page 360 also comprises a display area 366 in which retail products associated with the selected category, the selected sub-category, the selected sub-sub-category, and the brands included in the brand reply, are listed. In this embodiment, retail products of ranked brands are displayed in ranked order, according to the brand ranking, in an uppermost portion of the display area 366, and retail products of remaining unranked brands are displayed below the ranked brands in alphabetical order. In the embodiment shown, the graphical image 388a, the brand name 388b of the brand, the product description 388c and the selected category, the selected sub-category, and the selected sub-sub category 388d are shown for each listed retail product listed. Additionally, the display area 366 also comprises a check box 389 shown beside each listed retail product, which may be selected by the user to either select or deselect the product. The item selection page 360 also comprises an alphabetical index 390 comprising alphabetical letters, each of which may be selected for causing the display area 366 to scroll down to the first retail product of the unranked brands beginning with the selected letter. The item selection page 360 also comprises the free text search field 267 and the function bar 280, which have been described above and with reference to FIG. 4. The item selection page 360 also comprises an advertising banner 364, in which a graphical advertisement image comprising an embedded web link (not shown) to an advertiser's webpage is displayed, and which may be selected by the user to open a web browser window in which the advertiser's webpage is displayed. The item selection page 360 also comprises the menu bar 68.

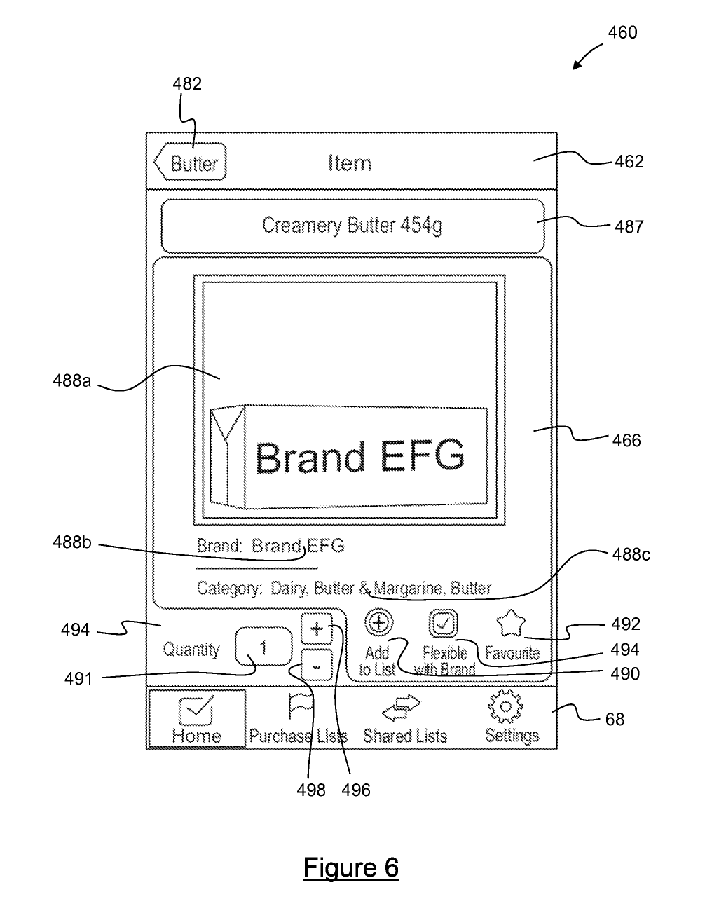

Upon selection of one of the retail products listed in the display area 366, the application program displays an item display page. FIG. 6 shows the item display page, which is generally referred to using reference numeral 460. The item display page 460 comprises a header region 462 comprising a virtual button, namely a return button 482, in which the selected sub-sub-category is displayed, and which may be selected by the user for returning to the item selection page 460. The item display page 460 also comprises a product banner 487 in which the product description of the selected retail product is displayed. The item display page 460 further comprises a display area 466 in which the graphical image 488a, the brand name 488b of the selected brand, and the selected category, the selected sub-category, and the selected sub-sub-category 488c of the selected retail product are displayed. The display area 466 also comprises a plurality of virtual buttons, namely: an add to list button 490, which may be selected by the user for adding the selected retail product to the active list, and in a quantity indicated in a quantity field 491; a favourite button 492, which may be selected to save the retail product as a favourite retail product for display on the favourites list page (not shown), and a “Flexible with Brand” button 494, which may be selected by the user to add a retail product of any brand having the selected category, the selected sub-category, and the selected sub-sub-category 488d, and in the quantity indicated in the quantity field 491, to the active list. The item display page 460 also comprises a quantity function bar 494 that has two (2) virtual buttons, namely a quantity increase button 496 and a quantity decrease button 498, which may be selected by the user for increasing and decreasing the quantity displayed in the quantity field 491. In this embodiment, the default quantity displayed in the quantity field 491 is one (1). The item display page 460 also comprises the menu bar 68.

Upon selection of the add to list button 490, the application program adds the selected quantity of the retail product to the active list, uploads the active list to the application server 22 as a saved list, and displays the active list page 160, updated to include the newly-added retail product.

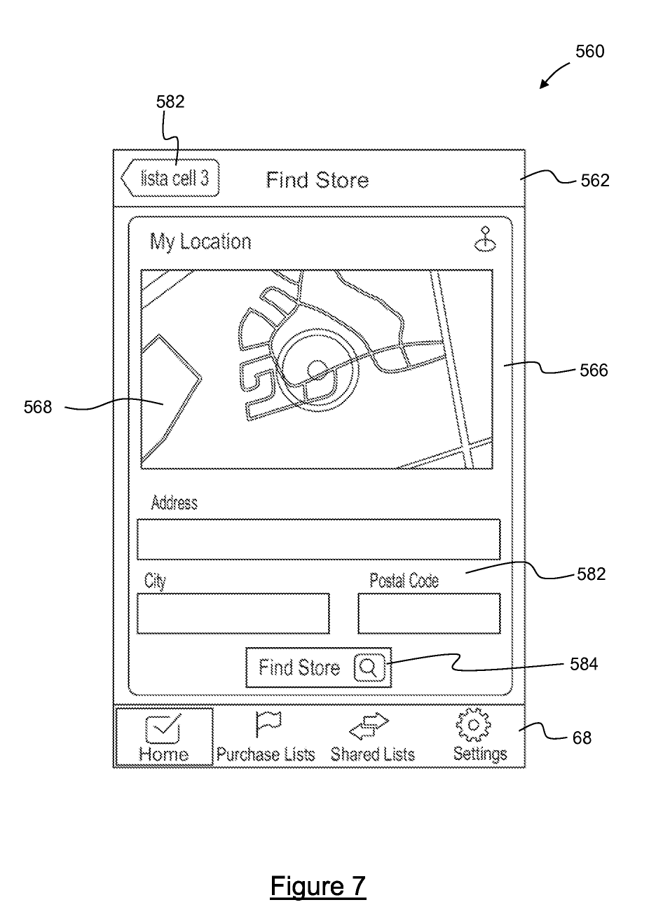

Turning again to FIG. 3, upon selection of the find store button 192, the application program displays a find store page, which is shown in FIG. 7 and is generally referred to using reference numeral 560. Find store page 560 comprises a header region 562 comprising a virtual button, and namely a return button 582, which may be selected by the user for returning to the list builder page 160. Find store page 560 also comprises a display area 566 in which a geographical map image 568 is shown. The find store page 560 also comprises a plurality of address entry fields 582, in which user-specified address information comprising a street address and a city, and/or a postal code, may be entered by the user. The find store page 560 further comprises a find store button 584. The find store page 560 also comprises the menu bar 68.

Upon selection of the find store button 584, the application program directs the computing device 48 to submit the active list to the shopping information application running on the application server 22 as a submitted list. The submitted list comprises the category, the sub-category, the sub-sub-category and the brand of all of the retail products listed in the active list, together with position information. If user-specified address information has been entered in any of the address entry fields 582, then the position information is an address corresponding to the user-specified address information. Otherwise, if no user-specified address information has been entered in any of the address entry fields 582, then the position information is the current geographical position of the computing device 48. In this embodiment, the current geographical position is global positioning system (GPS) coordinate data generated by the computing device 48.

Once the submitted list has been received, the application server 22 instructs the store controller server 24 to send current status information requests to all store servers 32 associated with stores that are within a threshold distance of the position information. In this embodiment, the threshold distance is fifteen (15) miles. Each current status information request comprises the category, the sub-category, the sub-sub-category, and the brand and the product code number of all of the retail products listed in the active list. In response, each store server 32 sends a current status information reply comprising one or more of current inventory information and in-store location information for each retail product of the submitted list to the store controller server 24. The application server 22 also instructs the store controller server 24 to search the store controller database and obtain, for each retail product of the submitted list, price information associated with stores that are within the threshold distance of the position information. The store controller server 24 forwards the current status information reply, and the obtained price information and associated store name and store location information, to the application server 22. The application server 22 also instructs the store portal server 26 to obtain coupon information, if any, from the store controller database for each retail product of the submitted list. In response, the store portal server 26 sends a reply comprising the obtained coupon information, if any, to the application server 22.

Upon receiving the replies, the application server 22 processes the current price information, the coupon information, the current inventory information, and the store location information, and calculates a total cost, a product matching ratio, and a store proximity for each store within the threshold distance. Here, the product matching ratio is a ratio of the number of retail products of the submitted list that are currently available in the store to the total number of retail products of the submitted list. The total cost is a sum of the price information for each of the retail products of the submitted list that are currently available in the store, and including the price reduction information of the coupon information (if any) so as to account for any available discount(s) provided thereby. The store proximity is the distance between the store and the position information. The application server 22 then sends a stores list, together with the coupon information, if any, to the sending computing device 48. Here, the stores list comprises the price information, the inventory information, the in-store location information, the matching ratio, the total cost, the store address and the store proximity for each store within the threshold distance.

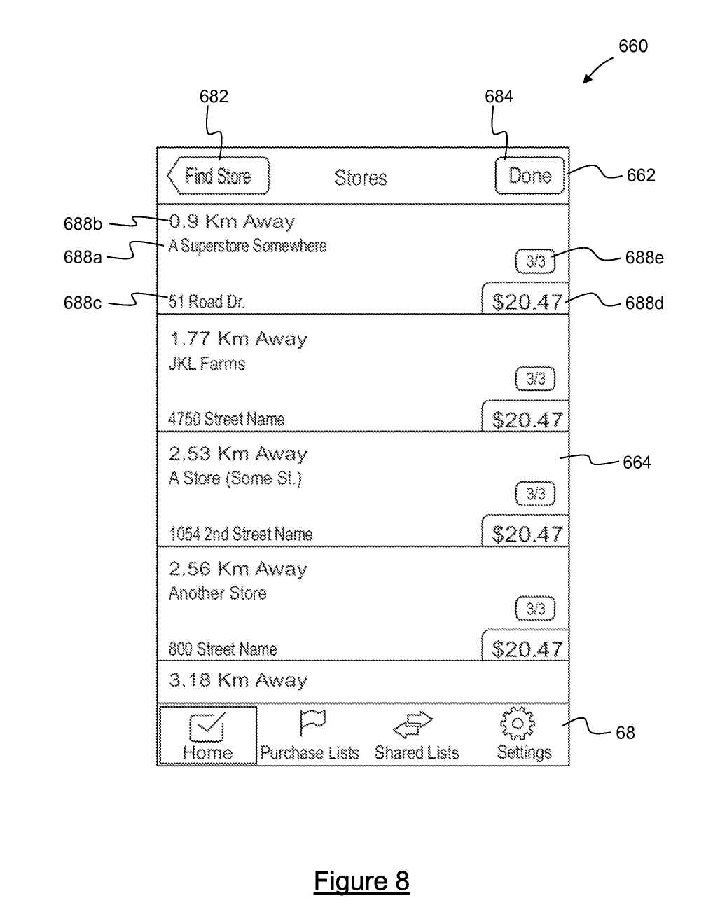

Once the stores list has been received, the application program displays a stores page on the display of the computing device 48. FIG. 8 shows the stores page, which is generally referred to using reference numeral 660. Stores page 660 comprises a header region 662 comprising two (2) virtual buttons, and namely a return button 682, which may be selected by the user for returning to the find store page 560, and a done button 684, which may be selected by the user for displaying a purchase lists page, described below. The stores page 660 also comprises display area 664 in which the stores of the stores list are listed in order of decreasing store proximity. For each stores listed, the store name 688a, the store proximity 688b, the store address 688c, the calculated total cost 688d and the product matching ratio 688e are displayed. Each store listed in the display area 664 is selectable by the user. The stores page 660 also comprises the menu bar 68.

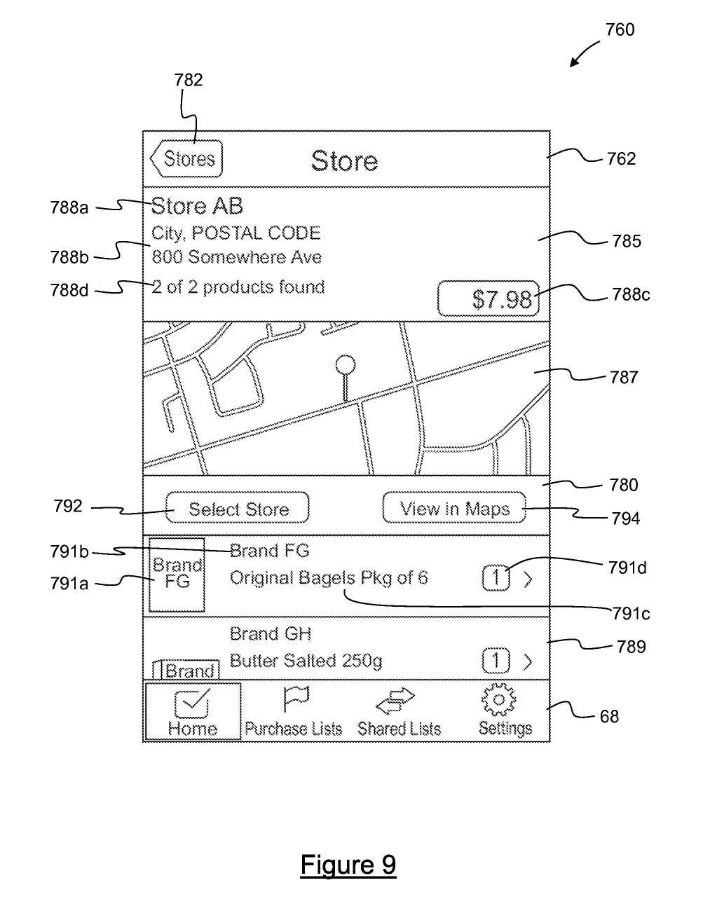

Upon selection of a listed store, the application program displays a store summary page on the display of the computing device 48. FIG. 9 shows the store summary page, which is generally referred to using reference numeral 760. Store summary page 760 comprises a header region 762 comprising a virtual button, and namely a return button 782, which may be selected by the user for returning to the stores page 660. Store summary page 760 also comprises an upper display area 785, in which the store name 788a, the store address 788b, the calculated total cost 788c and the product matching ratio 788d of the current store are displayed. Store summary page 760 also comprises a map display area 787, in which a map image showing the geographical location of the current store is shown. The store summary page 760 also comprises a function bar 780 that comprises two (2) virtual buttons, namely a “Select Store” button 792, which may be selected by a user for selecting the current store, and a “View in Maps” button 794, which may be selected by the user to open a new window (not shown) in which a full-sized map image showing the geographical location of the current store is shown. The store summary page 760 also comprises lower display area 789, in which the retail products of the currently active list that are currently available in the selected store are listed. For each retail product listed in the lower display area 789, the graphical image 791a, the brand name 791b of the brand, the product description 791c and the quantity 791d are shown. The store summary page 790 also comprises the menu bar 68.

Upon selection of the “Select Store” button 792, the application program saves the list of retail products of the currently active list that are currently available in the selected store, and which are displayed in the lower display area 789, as a purchase list in the computing device 48, and displays the stores page 660. The saved purchase list may be retrieved by selecting the purchase lists button 72 of the menu bar 68.

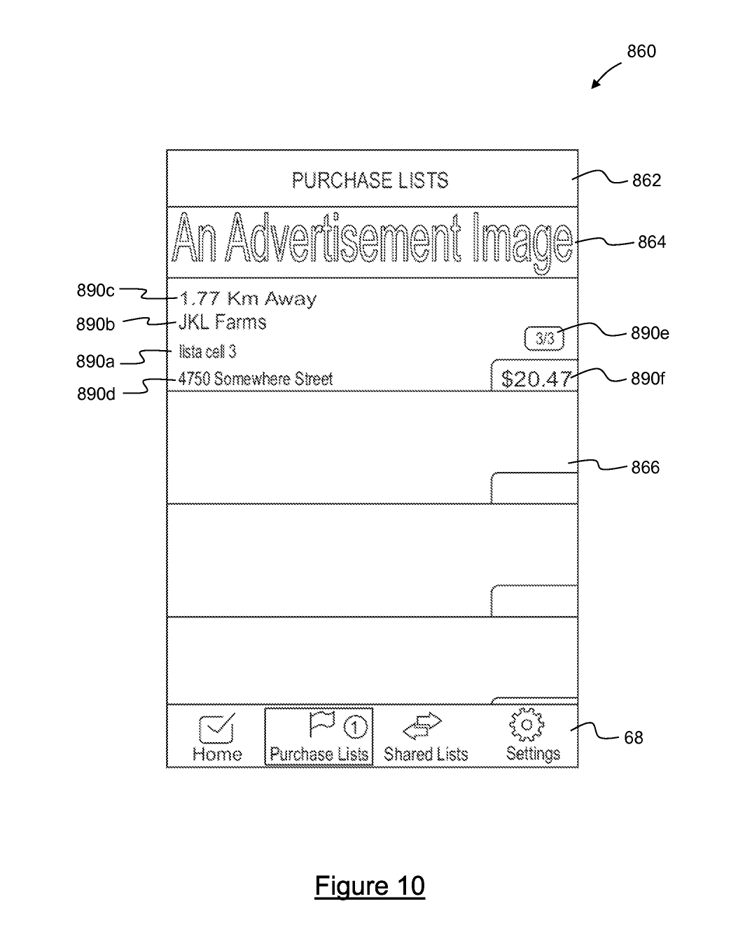

Upon selection of the purchase lists button 72, the application program displays a purchase lists page on the display of the computing device 48. FIG. 10 shows the purchase lists page, which is generally referred to using reference numeral 860. Purchase list page 860 comprises a header region 862, and further comprises a display region 866 in which the saved purchase lists are listed in order of saved time and date. Each purchase list listed in the display region 866 comprises the name of the active list 890a from which the purchase list was created, the store name 890b, the store proximity, the store address 890d, the product matching ratio 890e, and the calculated total cost 890f. The purchase lists page 860 also comprises an advertising banner 864, in which a graphical advertisement image comprising an embedded web link (not shown) to an advertiser's webpage is displayed, and which may be selected by the user to open a web browser window in which the advertiser's webpage is displayed. The purchase lists page 860 also comprises the menu bar 68.

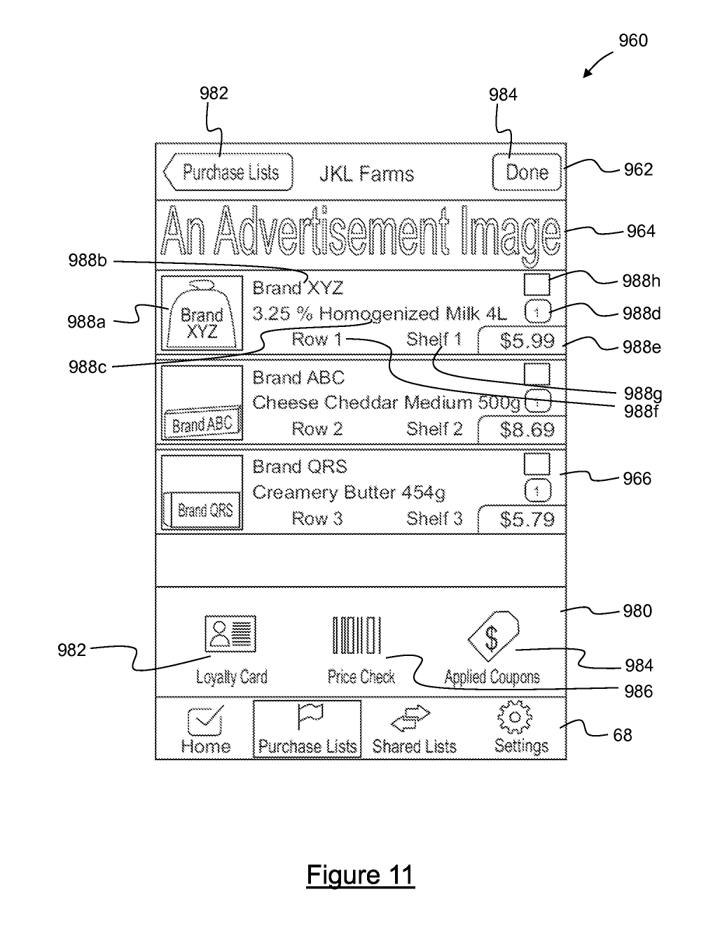

Each purchase list listed in the display area 866 may be selected by the user for displaying the contents thereof as an active purchase list. Upon selection of a purchase list, the application program displays an active purchase list page on the display of the computing device 48. FIG. 11 shows the active purchase list page, which is generally referred to using reference numeral 960. Active purchase list page 960 comprises a display area 966 in which the retail products of the active purchase list are shown. For each retail product of the active purchase list shown in the display area 966, the graphical image 988a, the brand name 988b of the brand, the sub-category 988c, the quantity 988d and the price 988e are shown. The in-store location information of the retail product is also shown in the display area 966, as a row 988f and a shelf 988g of the selected store. Each retail product displayed in the display area 966 of the active purchase list also has a check box 988h, which may be selected by the user for indicating that the retail product has been purchased. The active purchase list page 960 also comprises a header region 962 in which the name of the selected store is displayed. The header region 962 also comprises two (2) virtual buttons, namely a return button 982, which may be selected by the user for returning to the purchase lists page 860, and a done button 984, which may be selected by the user for saving the active purchase list, including any selections made to check box(es) 988h, and for returning to the purchase lists page 860. The active list page 960 also comprises a function bar 980 that has a plurality of virtual buttons, namely a loyalty card button 982, an applied coupons button 984, and a price check button 986.

The loyalty card button 982 may be selected to display a loyalty card page (not shown) on the display of the computing device 48. In this embodiment, the loyalty card page comprises a loyalty card image that comprises a graphic image indicating a logo of the selected store, and barcode information. Upon selecting the loyalty card button 982, the loyalty card image is displayed on the display of the computing device 48, for allowing the barcode information therein to be scanned by an optical scanner at a point of sale in the store, for example.

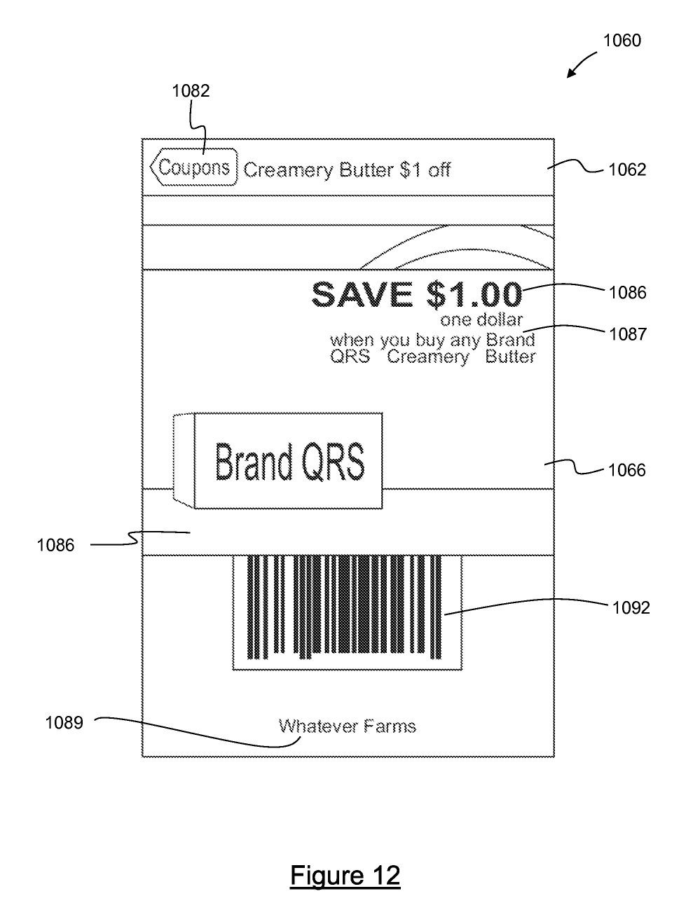

The applied coupons button 984 may be selected to display an applied coupons page (not shown), and which is generally similar to coupons page further described below. The applied coupons page comprises a list of coupons (not shown) that have been applied to the purchase list. Each coupon listed in the list may be selected to display a coupon display page on the display of the computing device 48, for allowing the barcode information therein to be scanned by an optical scanner at a point of sale in a store, for example. FIG. 12 shows the coupon display page, which is generally indicated by reference numeral 1060. Coupon display page 1060 comprises a header region 1062 comprising a virtual button, and namely a return button 1082, which may be selected by the user for returning to the applied coupons page. Coupon display page 1060 also comprises a display area 1066 in which the coupon graphical image 1086 is shown. The coupon graphical image 1086 comprises a text description 1087 of the associated retail product, and which includes text 1086 indicating a value of the price reduction information. The coupon display page also comprises a barcode image 1092 comprising the barcode information. The barcode image 1092 is of a suitably large size for allowing the barcode information therein, namely the price reduction information and product code number(s), to be scanned by an optical scanner at a point of sale in a store, for example. The coupon display page also comprises a store name field 1089, in which the store name associated with the coupon information is displayed, and in the example shown, the barcode information further comprises the store name.

Turning again to FIG. 11, upon selection of the price check button 986, the application program displays a message (not shown) on the active purchase list page 960 prompting the user to point the computing device 48 toward a “product barcode”, and directs the computing device 48 to capture one or more images using its imaging device. During image capture, the application program displays the one or more captured images on a display page (not shown) in real-time, and processes the one or more captured images to extract a product code number from any retail product barcode existing therein. As an example, the user may aim the computing device 48 toward a package of a desired retail product while shopping in the store. Upon extraction of a product code number, the application program directs the computing device 48 to send a price check request, which comprises the extracted product code number and the name of the selected store, to the application server 22. Upon receiving the price check request, the application server 22 obtains the price information for the retail product at the store, and sends the price information, the category information, the sub-category information, the sub-sub-category information, the brand information, the product description, and the graphical image of the retail product from the retail product database, in a price check reply to the computing device 48. Upon receiving the price check reply, the application program displays a price check page (not shown) comprising the price information, the category information, the sub-category information, the sub-sub-category information, the brand information, the product description, and the graphical image on the price check page, and prompts the user to add the retail product to the purchase list, if desired.

The active purchase list page 960 also comprises an advertising banner 964, in which a graphical advertisement image comprising an embedded web link (not shown) to an advertiser's webpage is displayed, and which may be selected by the user to open a web browser window in which the advertiser's webpage is displayed. The active purchase list page 960 also comprises the menu bar 68.

Turning again to FIG. 3, upon selection of the share button 190, the application program displays a list of user contacts (not shown) and a message (not shown) prompting the user to select one of the listed user contacts for sending the active list thereto. Upon selection of one of the user contacts, the application program uploads the active list and address information associated with the selected user contact to the application server 22, which stores the uploaded active list as a shared list. Upon launching the application program on another respective computing device 48 or 44 associated with the selected user contact, the application program downloads the shared list, which may be displayed on the respective computing device 48 or 44 by selecting the shared lists button 74.

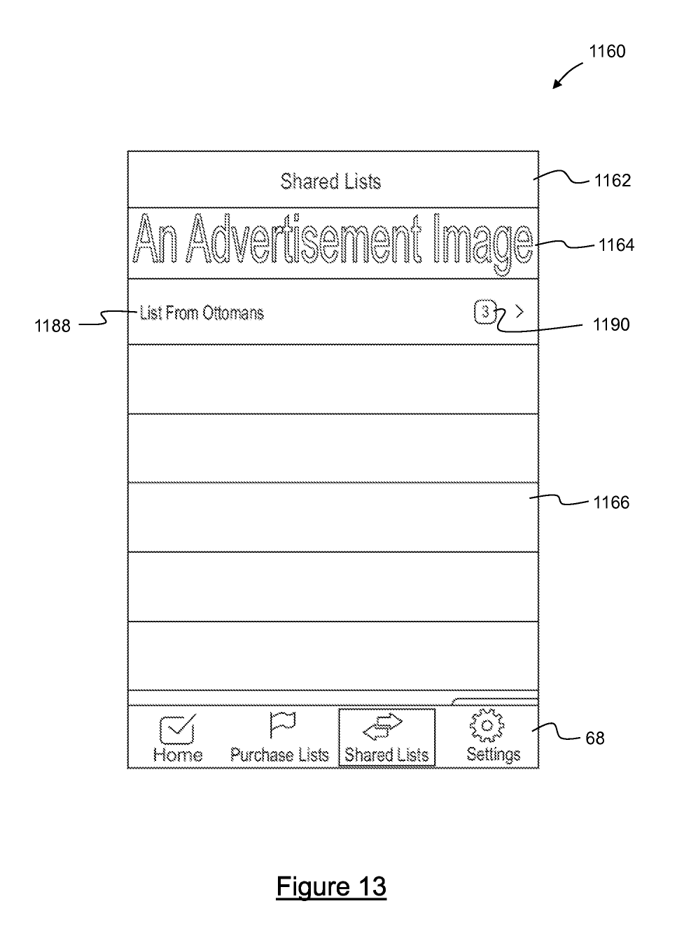

Turning again to FIG. 2, upon selection of the shared lists button 74, the application program displays a shared lists page on the display of the computing device 48. FIG. 13 shows the shared lists page, which is generally referred to using reference numeral 1160. The shared lists page comprises a header region 1162, and further comprises a display region 1166 in which the shared lists are listed in order of saved time and date. Each shared list shown in the display region 1166 comprises a name 1188 that comprises the name of the user or users who shared the list, and an indicator 1190 that indicates the number of retail products listed therein. The shared lists page 1160 also comprises an advertising banner 1164, in which a graphical advertisement image comprising an embedded web link (not shown) to an advertiser's webpage is displayed, and which may be selected by the user to open a web browser window in which the advertiser's webpage is displayed. The shared lists page 1160 also comprises the menu bar 68.

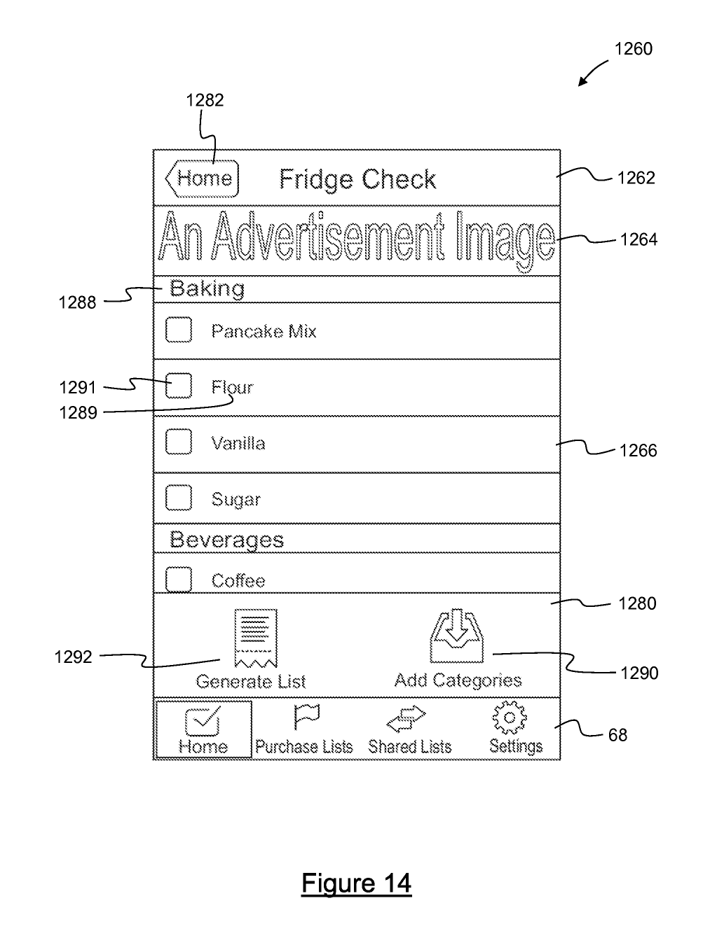

Upon selection of the “Fridge Check” button 84, the application program displays the fridge check page. FIG. 14 shows the fridge check page, which is generally referred to using reference numeral 1260. Fridge check page 1260 comprises a header region 1262 comprising a virtual button, and namely a return button 1282, which may be selected by the user for returning to the lists page 60. The fridge check page 1260 also comprises a display area 1266 in which some of the categories 1288 of the downloaded catalog information are listed in alphabetical order. Some of the sub-categories 1289 of the downloaded catalog information are listed in alphabetical order under their respective category 1288 in the display area 1266. For each sub-category shown in the display area 1266, a check box 1291 is shown, and which may be selected by the user. The fridge check page 1260 also comprises a function bar 1280 that comprises two (2) virtual buttons, namely an “Add Categories” button 1290 and a “Generate List” button 1292. The fridge check page 1260 also comprises an advertising banner 1264, in which a graphical advertisement image comprising an embedded web link (not shown) to an advertiser's webpage is displayed, and which may be selected by the user to open a web browser window in which the advertiser's webpage is displayed. The fridge check page 1260 also comprises the menu bar 68.

In this embodiment, the categories 1288 and sub-categories 1289 listed in the display area 1266 comprise a predefined subset of a categories and sub-categories, and generally correspond to commonly-purchased retail items according to general consumer trends. Upon selection of the “Add Categories” button 1290, the application program displays text entry fields (not shown) in which the user may enter desired text to create a user-defined category and a user-defined sub-category, and adds the user-defined category and the user-defined sub-category to the predefined subset of a categories and sub-categories. Once a category and a sub-category have been entered into the text entry fields, the application program displays the category selection page 260, the sub-category selection page, the sub-sub-category page, and the item selection page to allow the user to select a retail product, as described above. Upon selection of a retail product, the application program adds the user-defined category and the user-defined sub-category to the predefined subset of categories and sub-categories, and associates the selected retail product with the user-defined sub-category.

Upon selection of the “Generate List” button 1292, the application program displays the list builder page 160, and generates a new list and adds, for each selected check box 1291, a retail product having the category 1288, the sub-sub-category 1289, and a brand previously assigned by the user for the selected category to the new list. If no brand has been previously assigned by the user for the selected category, the application program displays the sub-sub-category selection page, where the user may select sub-sub-category, and in turn to the item selection page, where the user may select a brand. The application program uploads the brand selected by the user to the application server 22, where it is saved until the user of the computing device 48.

Turning again to FIG. 3, upon selection of the scan code button 192, the application program displays a message (not shown) on the list building page 160 prompting the user to point the computing device 48 toward a “product barcode”, and directs the computing device 48 to capture one or more images using its imaging device. During image capture, the application program displays the one or more captured images on a display page (not shown) in real-time, and to process the one or more captured images to extract a product code number from any retail product barcode existing therein. As an example, the user may aim the computing device 48 toward a package of a desired retail product while shopping in the store. Upon extraction of a product code number, the application program directs the computing device 48 to send a product identification request, which comprises the extracted product code number, to the application server 22. Upon receiving the product identification request, the application server 22 searches the retail product database and obtains the product description and the graphical image for the retail product associated with the extracted product code number. The application server 22 then sends a product identification reply comprising the product description and the graphical image to the computing device 48. Upon receiving the product identification reply, the application program displays the information in the display item page, described above and with reference to FIG. 6.

Upon selection of the coupons button 196, the application program directs the computing device 48 to submit a local coupons request to the application server 22. The local coupons request comprises the position information described above and with reference to FIG. 4.

Once the local coupons request has been received, the application server 22 communicates with the store portal server 26, and obtains from the store portal server 26 all available coupon information. The application server 22 then sends a local coupons reply to the computing device 48 comprising the obtained coupon information.

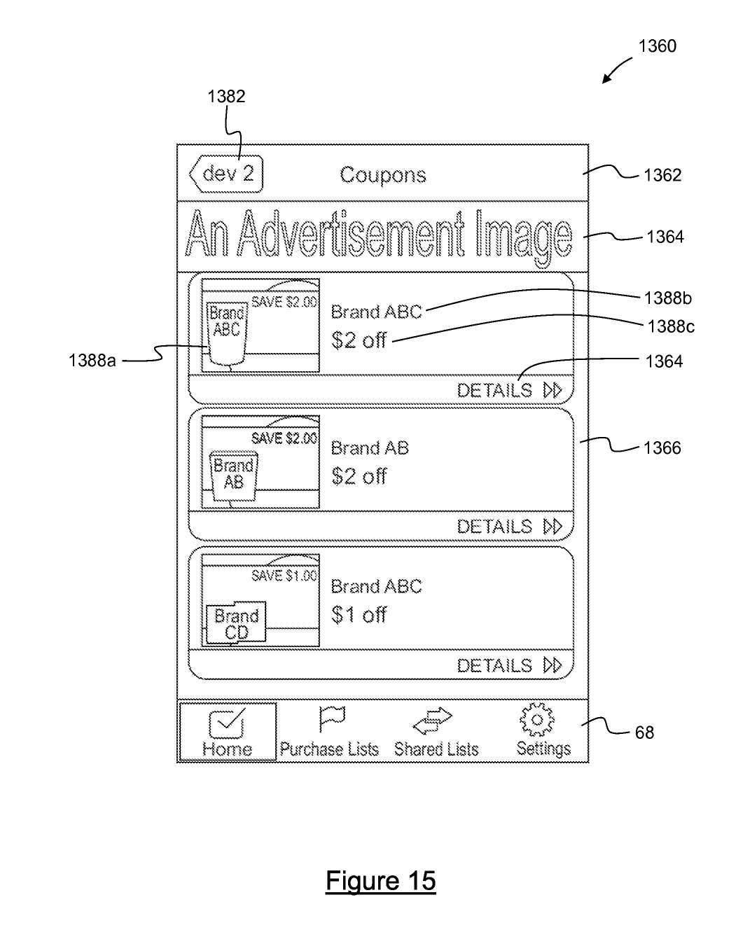

Upon receiving the local coupons reply, the application program displays a coupons page on the display of the computing device 48. FIG. 15 shows the coupons page, which is generally referred to using reference numeral 1360. Coupons page 1360 comprises a header region 1362 comprising a virtual button, and namely a return button 1382, which may be selected by the user for returning to the list builder page 160. Coupons page 1360 also comprises a display area 1366 in which the obtained coupons are listed. In the embodiment shown, the graphical image 1388a, the brand 1388b, and a price savings 1388c are shown for each coupon listed in the display area 1366. Each coupon listed in the display area 1366 may be selected to add the retail product associated with the coupon to the active list. The coupons page 1360 also comprises an advertising banner 1364, in which a graphical advertisement image comprising an embedded web link (not shown) to an advertiser's webpage is displayed, and which may be selected by the user to open a web browser window in which the advertiser's webpage is displayed. The purchase lists page 1360 also comprises the menu bar 68.

Turning now to the computing devices 44, each computing device 44 is configured to communicate with the shopping information application through an Internet web browser application running on the computing device 44. When a user directs the web browser application to the Internet website hosted by the application server 22, the shopping information application presents a graphical user web interface within a web browser window on the computing device 44, through which the user of the computing device 44 may interact with the shopping information application. In the embodiment shown, the computing devices 44 communicate with the Internet network 30 directly, however, it will be understood that the computing devices 44 may alternatively communicate with the Internet network 30 via the cellular network 46.

The graphical user web interface comprises a variety of different pages that are displayed within the web browser window, and which are generally similar to the lists page 60, the list builder page 160, the category selection page 260, the sub-category selection page, the sub-sub-category selection page, the item selection page 360, the item display page 460, the find store page 560, the stores page 660, the store summary page 760, the purchase lists page 860, the active purchase list page 960, the coupon display page 1060, the shared lists page 1160, the fridge check page 1260, and the coupons page 1360 described above and with reference to FIGS. 2 to 15, but which may differ in page shape and in the dimensions of graphical items displayed therein, as appropriate. The functioning of the graphical user web interface presented on the computing devices 44 is generally similar to the functioning of the graphical user interface presented by the application program on the computing devices 48.

Although in embodiments described above, the application program is configured to download catalog information that comprises a high-level portion of the categorizing information, namely the category information and the sub-category information, for all retail products stored in the retail product database, in other embodiments, the application program may alternatively be configured to download catalog information that comprises all of the categorizing information, namely the category information, the sub-category information and the brand information, for all retail products stored in the retail product database, and brand rankings, according to the preferences defined by the advertising engine, for all retail products stored in the retail product database. In this embodiment, once the sub-category has been selected, the application program does not direct the computing device to send a brand request, but rather searches the downloaded catalog information and obtains a list of all brands having the selected category and the selected sub-category. The application program then searches the downloaded catalog information and obtains the brand rankings for the brands obtained during the search. The application program then displays the item selection page, in which the retail products associated with the selected category, the selected sub-category and the brands obtained during the search, are listed in ranked order according to the brand rankings.

Although in embodiments described above, the position information of the submitted list is the current geographical position of the computing device, in other embodiments, the position information may alternatively be a geographical position that is manually entered by the user of the computing device, such as for example, a geographical position at which the user is expected to be in the future.

The methods described above may be embodied in one or more software applications comprising computer executable instructions executed by computer servers, desktop computers, laptop computers, notebook computers, tablet computers, PDAs, smartphones and/or other suitable information computing devices. The software applications may comprise program modules including routines, programs, object components, data structures, and the like, and may be embodied as computer readable program code stored on a computer readable medium. The computer readable medium is any data storage device that can store data. Examples of computer readable media include for example read-only memory, random-access memory, CD-ROMs, magnetic tape, USB keys, flash drives and optical data storage devices. The computer readable program code can also be distributed over a network including coupled computer systems so that the computer readable program code is stored and executed in a distributed fashion.

Although in embodiments described above, the application server, the store controller server and the store portal server are described as a plurality of server computing devices that are in communication with each other via a LAN, those skilled in the art will appreciate that one or more of the application server, the store controller server and the store portal server may alternatively be physically located within one (1) physical server, and may thereby be operated as separate server instances within that one (1) physical server. In a related embodiment, the application server, the store controller server may alternatively be physically located within two (2) physical servers.

Although in embodiments described above, each product code number is a Universal Product Code (UPC)-A number, in other embodiments, the product code number may alternatively be another form of product code number. For example in, other embodiments, the product code number may be stock-keeping unit (SKU) number.

Although in embodiments described above, each graphical image is a photographic image of the retail product, in other embodiments, each graphical image may alternatively be another form of graphical image of the retail product. For example in, other embodiments, the graphical image may be a drawing of the retail product.

Although in embodiments described above, the application program allows the user to add each individual retail product to the active list by selecting the category, the sub-category, the sub-sub-category and the brand of the retail product sequentially, in other embodiments, the application program may alternatively allow the user to add each individual retail product to the active list by selecting only the category, the sub-category and the brand of the retail product sequentially. In a related embodiment, for each retail product, the product categorizing information may alternatively comprise a category, a sub-category, and a brand, and once the sub-category has been selected, the application program directs the computing device to send the brand request, which comprises the selected category and the selected sub-category, to the application server, and in turn receives a brand reply from the application server and displays the information received in the brand reply in the item selection page for allowing the user to select the retail product.

Although embodiments have been described above with reference to the accompanying drawings, those of skill in the art will appreciate that variations and modifications may be made without departing from the scope thereof as defined by the appended claims.

What is claimed is:

1. A method comprising:
creating, using a computing device, a list of one or more retail products by sequentially selecting, at least, category information, sub-category information and brand information displayed for each of said one or more retail products, said brand information being displayed in accordance with an advertisement ranking;
sending a request to an application server for price information of said one or more retail products, the application server being in communication with a database comprising price information for each of said one or more retail products for at least one store; and
displaying, on the computing device, requested price information of said one or more retail products for one or more of said at least one store.

2. The method of claim 1, further comprising:
sending an initial request to the application server for said brand information.

3. The method of claim 2, wherein said application server provides said advertisement ranking.

4. The method of claim 1, further comprising:
displaying, on the computing device, a graphical advertisement image received from the application server.

5. The method of claim 1, wherein said displaying further comprises:
displaying, on the computing device, a graphical image of each of said one or more retail products.

6. The method of claim 1, wherein the application server applies coupon information to said price information, said requested price information being reduced by said coupon information.

7. The method of claim 1, wherein the application server is also in communication with at least one store server maintaining a current inventory information database comprising current inventory information for a respective one of said at least one store, and wherein said sending further comprises:
sending a request for current inventory information of said one or more retail products,
and wherein said displaying further comprises:
displaying requested current inventory information of said one or more retail products for said respective store.

8. The method of claim 1, wherein the computing device is a portable wireless computing device.

9. The method of claim 7, wherein the computing device is a smartphone.

10. The method of claim 1, further comprising sending the list of one or more retail products to another computing device as a shared list.

11. The method of claim 1, wherein the creating further comprises sequentially selecting the category information and the sub-category information from a predefined subset of category information and sub-category information, said predefined subset corresponding to commonly-purchased retail items.

12. The method of claim 11, further comprising:
adding one or more of a user-defined category and a user-defined sub-category to said predefined subset.

13. The method of claim 12, further comprising:
associating a selected retail product with said user-defined sub-category.

14. A non-transient computer-readable medium storing computer-readable code which, when executed, causes a computing device to:
display a user interface for creating a list of one or more retail products by sequentially selecting, at least, category information, sub-category information and brand information displayed for each of said one or more retail products, said brand information being displayed in accordance with an advertisement ranking;
send a request to an application server for price information of said one or more retail products, the application server being in communication with a database comprising price information for each of said one or more retail products for at least one store; and
display requested price information of said one or more retail products for one or more of said at least one store.

15. The non-transient computer-readable medium of claim 14, further comprising computer-readable code which, when executed, causes the computing device to:
send an initial request to the application server for said brand information.

16. The non-transient computer-readable medium of claim 14, further comprising computer-readable code which, when executed, causes the computing device to:
display a graphical advertisement image received from the application server.

17. The non-transient computer-readable medium of claim 14, further comprising computer-readable code which, when executed, causes the computing device to:
display a graphical image of each of said one or more retail products.

18. The non-transient computer-readable medium of claim 14, wherein the application server is also in communication with at least one store server maintaining a current inventory information database comprising current inventory information for a respective one of said at least one store, and further comprising computer-readable code which, when executed, causes the computing device to:
send a request for current inventory information of said one or more retail products, and
display requested current inventory information of said one or more retail products for said respective store.

19. The non-transient computer-readable medium of claim 14, further comprising computer-readable code which, when executed, causes the computing device to:
send a price check request to the application server, the price check request comprising barcode information associated with a desired retail product and current position information of the computing device; and
display price information of said desired retail product for a store associated with the current position information.

20. A shopping information system comprising:
an application server in communication with a database comprising price information for each of a plurality of retail products for at least one store; and
at least one computing device in communication with the application server, the at least one computing device being configured to:
display a user interface for creating a list of one or more retail products by sequentially selecting, at least, category information, sub-category information and brand information displayed for each of said one or more retail products, said brand information being displayed in accordance with an advertisement ranking;
send a request to the application server for price information of said one or more retail products; and
display requested price information of said one or more retail products for one or more of said at least one store.
